(19) United States
(12) Patent Application Publication
(10) Pub. No.: US 2023/0012128 A1
(43) Pub. Date: Jan. 12, 2023

(54) MILLIMETER WAVE RADAR APPARATUS DETERMINING OBSTACLE ON RAILWAY

(71) Applicant: WANSHIH ELECTRONIC CO., LTD., New Taipei City (TW)

(72) Inventors: Chun-Chi KO, New Taipei City (TW); Shih-Yun LIN, New Taipei City (TW); Tsai-Ling YU, New Taipei City (TW)

(21) Appl. No.: 17/372,511

(22) Filed: Jul. 11, 2021

(51) Int. Cl. B61L 23/04; G01S 13/93; G01S 7/03

(52) U.S. Cl. CPC B61L 23/041; G01S 13/93; G01S 7/03; G01S 2013/9328

(57) ABSTRACT

A millimeter wave radar apparatus determining an obstacle on a railway is applied to the railway and the obstacle. The millimeter wave radar apparatus includes a user interface and a millimeter wave radar. The user interface is configured to control the millimeter wave radar. The millimeter wave radar is configured to transmit a radar wave to a predetermined range on the railway. The millimeter wave radar is configured to receive a reflected radar wave reflected from the predetermined range on the railway based on the radar wave. The user interface is configured to determine whether the obstacle is in the predetermined range on the railway based on the reflected radar wave. If the user interface determines that the obstacle is in the predetermined range on the railway, the user interface is configured to provide a warning.

### BACKGROUND

### Technical Field

The present disclosure relates to a millimeter wave radar apparatus, and especially relates to a millimeter wave radar apparatus determining an obstacle on a railway.

### Description of Related Art

A train traveling fast on a railway often carries a large number of passengers or goods, so the safety of the train is very important. One of the most important factors affecting the safety of the train is whether there is an obstacle on the railway. Once there is the obstacle on the railway, the passing train will be very dangerous. However, the current railway obstacle warning system is often not real-time and accurate, which seriously affects the safety of the train.

### SUMMARY OF THE DISCLOSURE

In order to solve the above-mentioned problems, an object of the present disclosure is to provide a millimeter wave radar apparatus determining an obstacle on a railway.

In order to achieve the object of the present disclosure mentioned above, the millimeter wave radar apparatus of the present disclosure is applied to the railway and the obstacle. The millimeter wave radar apparatus includes a user interface and a millimeter wave radar. The millimeter wave radar is electrically connected to the user interface. Moreover, the user interface is configured to control the millimeter wave radar. The millimeter wave radar is configured to transmit a radar wave to a predetermined range on the railway. The millimeter wave radar is configured to receive a reflected radar wave reflected from the predetermined range on the railway based on the radar wave. The user interface is configured to determine whether the obstacle is in the predetermined range on the railway based on the reflected radar wave. If the user interface determines that the obstacle is in the predetermined range on the railway, the user interface is configured to provide a warning.

Moreover, in an embodiment of the millimeter wave radar apparatus of the present disclosure mentioned above, the millimeter wave radar apparatus further includes a camera lens electrically connected to the user interface. Moreover, the user interface is configured to control the camera lens. If the user interface determines that the obstacle is in the predetermined range on the railway, the user interface is configured to control the camera lens to photograph the obstacle in the predetermined range on the railway.

Moreover, in an embodiment of the millimeter wave radar apparatus of the present disclosure mentioned above, moreover the user interface includes a microprocessor electrically connected to the millimeter wave radar and the camera lens.

Moreover, in an embodiment of the millimeter wave radar apparatus of the present disclosure mentioned above, moreover the microprocessor includes a dynamic object tracking unit electrically connected to the millimeter wave radar. Moreover, the dynamic object tracking unit includes a point cloud capturing subunit electrically connected to the millimeter wave radar. Moreover, the point cloud capturing subunit is configured to obtain a point cloud information based on the reflected radar wave.

Moreover, in an embodiment of the millimeter wave radar apparatus of the present disclosure mentioned above, moreover the dynamic object tracking unit further includes a point cloud reliability checking subunit electrically connected to the point cloud capturing subunit. Moreover, the point cloud reliability checking subunit is configured to check the point cloud information.

Moreover, in an embodiment of the millimeter wave radar apparatus of the present disclosure mentioned above, moreover the dynamic object tracking unit further includes a point cloud classification subunit electrically connected to the point cloud capturing subunit. Moreover, if the point cloud information checked by the point cloud reliability checking subunit is correct, the point cloud capturing subunit is configured to transmit the point cloud information to the point cloud classification subunit. The point cloud classification subunit is configured to classify the point cloud information to obtain a point cloud classification information.

Moreover, in an embodiment of the millimeter wave radar apparatus of the present disclosure mentioned above, moreover the dynamic object tracking unit further includes a point cloud variation tracking subunit electrically connected to the point cloud classification subunit.

Moreover, the point cloud classification subunit is configured to transmit the point cloud classification information to the point cloud variation tracking subunit. The point cloud variation tracking subunit is configured to determine whether the obstacle is dynamically in the predetermined range on the railway based on the point cloud classification information, and the point cloud variation tracking subunit is configured to determine a moving track and a moving speed of the obstacle based on the point cloud classification information. If the point cloud variation tracking subunit determines that the obstacle is dynamically in the predetermined range on the railway based on the point cloud classification information, the user interface is configured to determine that the obstacle is in the predetermined range on the railway based on the reflected radar wave.

Moreover, in an embodiment of the millimeter wave radar apparatus of the present disclosure mentioned above, moreover the microprocessor further includes a static object determining unit electrically connected to the millimeter wave radar. Moreover, before the millimeter wave radar starts to determine/detect/scan, the millimeter wave radar and the static object determining unit are configured to use a range angle spectrum technology to record a background reflection information in the predetermined range on the railway. Then, after the millimeter wave radar starts determining/detecting/scanning, the millimeter wave radar and the static object determining unit are configured to subtract the background reflection information from a current reflection information to determine whether the obstacle is statically in the predetermined range on the railway. If the millimeter wave radar and the static object determining unit determine that the obstacle is statically in the predetermined range on the railway more than a predetermined time, the user interface is configured to determine that the obstacle is in the predetermined range on the railway based on the reflected radar wave.

Moreover, in an embodiment of the millimeter wave radar apparatus of the present disclosure mentioned above, the millimeter wave radar apparatus is applied to a cloud system, wherein the user interface further includes a warning lamp and an alarm bell. The warning lamp is electrically connected to the microprocessor. The alarm bell is electrically connected to the microprocessor. Moreover, if the user interface determines that the obstacle is in the predetermined range on the railway, the user interface is configured to control the camera lens to photograph the obstacle in the predetermined range on the railway to upload to the cloud system, and the user interface is configured to light the warning lamp, and the user interface is configured to drive the alarm bell to generate a warning sound. The warning lamp is configured to further display the warning. The cloud system is configured to store an incident screen photo, an obstacle distance, an incident location coordinate and an incident time.

Moreover, in an embodiment of the millimeter wave radar apparatus of the present disclosure mentioned above, moreover the user interface further includes a timer electrically connected to the microprocessor. Moreover, if the user interface determines that the obstacle is in the predetermined range on the railway, the user interface is configured to provide the warning and is configured to utilize the timer to record an appearance time of the obstacle. If the user interface determines that the obstacle leaves the predetermined range on the railway, the user interface is configured to stop providing the warning and is configured to utilize the timer to record a departure time of the obstacle.

The advantage of the present disclosure is to promptly and accurately warn that the obstacle is on the railway, so as to improve the safety of the train running on the railway.

Please refer to the detailed descriptions and figures of the present disclosure mentioned below for further understanding the technology, method and effect of the present disclosure achieving the predetermined purposes. It believes that the purposes, characteristic and features of the present disclosure can be understood deeply and specifically. However, the figures are only for references and descriptions, but the present disclosure is not limited by the figures.

### BRIEF DESCRIPTION OF THE DRAWINGS

FIG. 1 shows a block diagram of the millimeter wave radar apparatus of the present disclosure.

FIG. 2 shows a first application situation of the millimeter wave radar apparatus of the present disclosure.

FIG. 3 shows a second application situation of the millimeter wave radar apparatus of the present disclosure.

FIG. 4 shows a third application situation of the millimeter wave radar apparatus of the present disclosure.

FIG. 5 shows a fourth application situation of the millimeter wave radar apparatus of the present disclosure.

FIG. 6 shows a block diagram of an embodiment of the microprocessor of the present disclosure.

FIG. 7 shows a block diagram of an embodiment of the millimeter wave radar of the present disclosure.

FIG. 8 shows a block diagram of an embodiment of the analog-to-digital circuit of the present disclosure.

FIG. 9 shows a partial block diagram of an embodiment of the millimeter wave receiving circuit of the present disclosure.

FIG. 10 shows another partial block diagram of the embodiment of the millimeter wave receiving circuit of the present disclosure.

FIG. 11 shows a block diagram of an embodiment of the millimeter wave transmitting circuit of the present disclosure.

### DETAILED DESCRIPTION

In the present disclosure, numerous specific details are provided, to provide a thorough understanding of embodiments of the disclosure. Persons of ordinary skill in the art will recognize, however, that the present disclosure can be practiced without one or more of the specific details. In other instances, well-known details are not shown or described to avoid obscuring aspects of the present disclosure. Now please refer to the figures for the explanation of the technical content and the detailed description of the present disclosure:

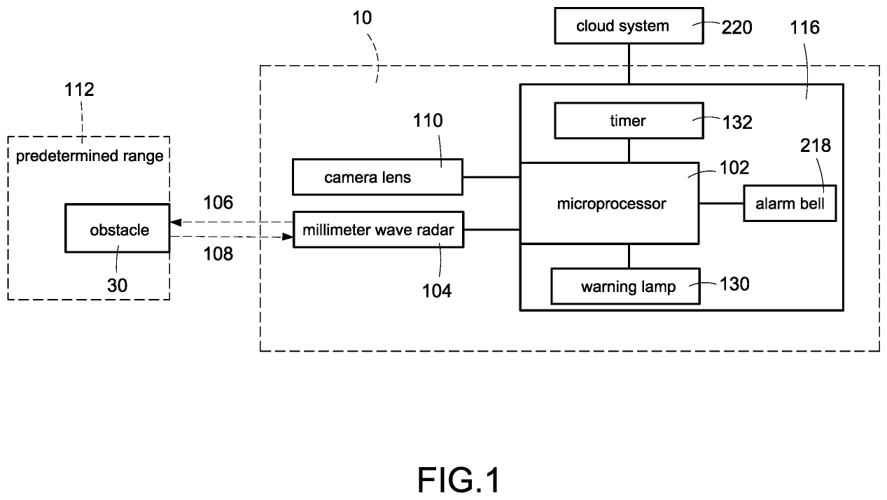

FIG. 1 shows a block diagram of the millimeter wave radar apparatus of the present disclosure. A millimeter wave radar apparatus 10 determining an obstacle on a railway of the present disclosure includes a user interface 116, a millimeter wave radar 104 and a camera lens 110. The user interface 116 includes a microprocessor 102, a warning lamp 130, an alarm bell 218 and a timer 132. The components mentioned above are electrically connected to each other. The present disclosure only needs the user interface 116 and the millimeter wave radar 104 to achieve the effect and the purpose of the present disclosure.

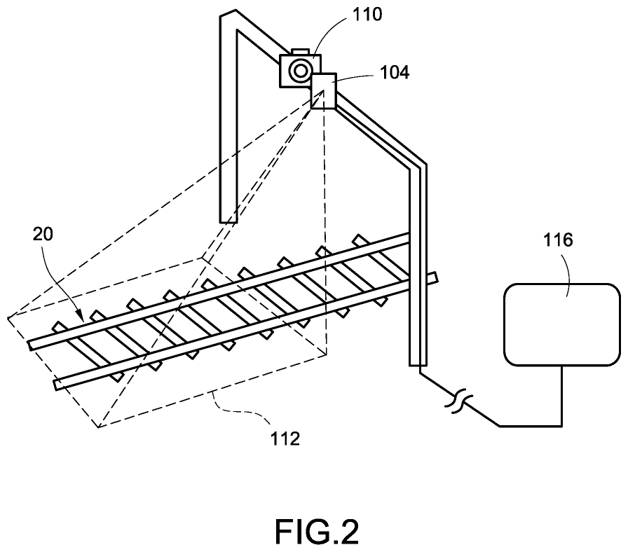

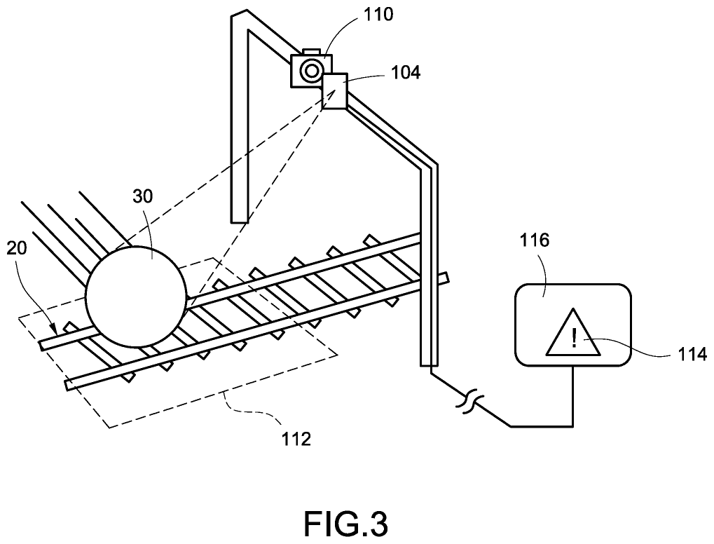

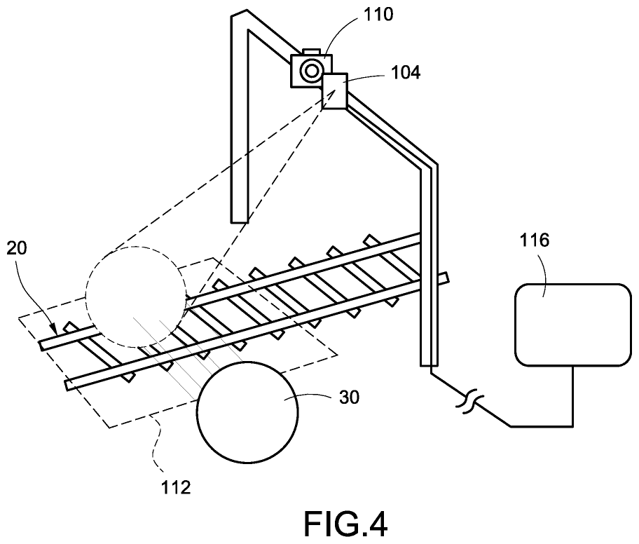

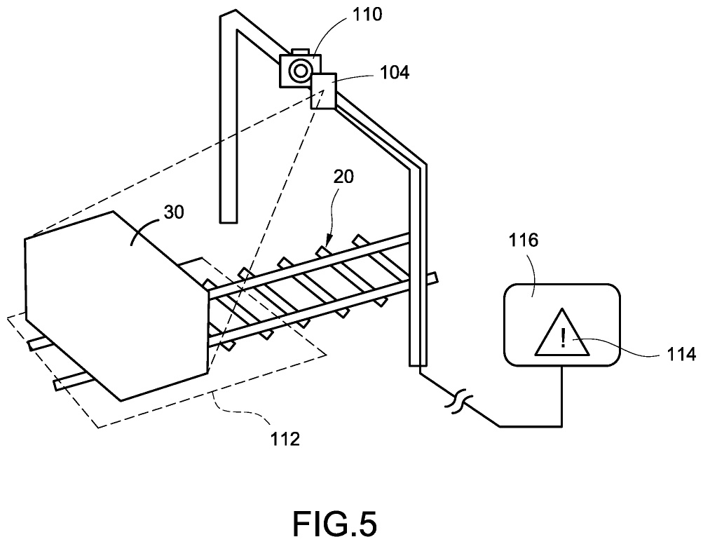

FIG. 2 shows a first application situation of the millimeter wave radar apparatus of the present disclosure. FIG. 3 shows a second application situation of the millimeter wave radar apparatus of the present disclosure. FIG. 4 shows a third application situation of the millimeter wave radar apparatus of the present disclosure. FIG. 5 shows a fourth application situation of the millimeter wave radar apparatus of the present disclosure. Please refer to FIG. 1 to FIG. 5 at the same time for the following contents.

The millimeter wave radar apparatus 10 of the present disclosure is applied to a railway 20, an obstacle 30 and a cloud system 220. The user interface 116 is configured to control the millimeter wave radar 104 and the camera lens 110. The millimeter wave radar 104 is configured to transmit a radar wave 106 to a predetermined range 112 on the railway 20. The millimeter wave radar 104 is configured to receive a reflected radar wave 108 reflected from the predetermined range 112 on the railway 20 based on the radar wave 106. The user interface 116 is configured to determine whether the obstacle 30 is in the predetermined range 112 on the railway 20 based on the reflected radar wave 108. Moreover, the millimeter wave radar 104 and the camera lens 110 can be arranged at any locations/positions/places of the periphery of the railway 20.

If the user interface 116 determines that the obstacle 30 is in the predetermined range 112 on the railway 20, the user interface 116 is configured to provide a warning 114, and the user interface 116 is configured to light the warning lamp 130, and the user interface 116 is configured to drive the alarm bell 218 to generate a warning sound, and the warning lamp 130 is configured to further display the warning 114, and the user interface 116 is configured to utilize the timer 132 to record an appearance time of the obstacle 30, and the user interface 116 is configured to control the camera lens 110 to photograph the obstacle 30 in the predetermined range 112 on the railway 20 to upload to the cloud system 220. The cloud system 220 is configured to store an incident screen photo, an obstacle distance, an incident location coordinate and an incident time.

If the user interface 116 determines that the obstacle 30 leaves the predetermined range 112 on the railway 20, the user interface 116 is configured to stop providing the warning 114 and is configured to utilize the timer 132 to record a departure time of the obstacle 30.

FIG. 2 shows that the millimeter wave radar 104 is determining whether the obstacle 30 is in the predetermined range 112 on the railway 20, and FIG. 2 shows that the obstacle 30 is not in the predetermined range 112 on the railway 20. FIG. 3 shows that the millimeter wave radar 104 determines that the obstacle 30 (for example, a falling rock) is in the predetermined range 112 on the railway 20, and the user interface 116 provides the warning 114 and records the appearance time of the obstacle 30, and the camera lens 110 photographs the obstacle 30 in the predetermined range 112 on the railway 20. FIG. 4 shows that the obstacle 30 leaves the predetermined range 112 on the railway 20, and the user interface 116 stops providing the warning 114, and the user interface 116 records the departure time of the obstacle 30. FIG. 5 shows another kind of obstacle 30, for example, a vehicle that breaks into the railway 20.

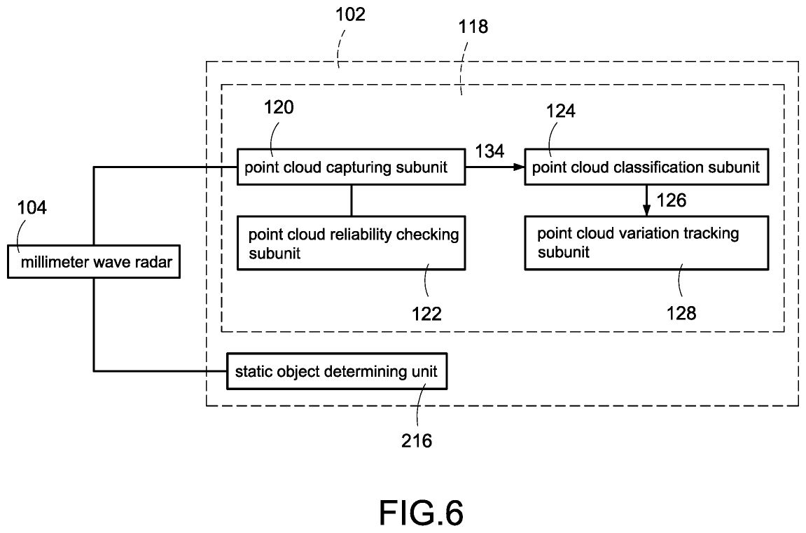

FIG. 6 shows a block diagram of an embodiment of the microprocessor of the present disclosure. Please refer to FIG. 1 to FIG. 5 at the same time. The microprocessor 102 includes a dynamic object tracking unit 118 and a static object determining unit 216. The dynamic object tracking unit 118 includes a point cloud capturing subunit 120, a point cloud reliability checking subunit 122, a point cloud classification subunit 124 and a point cloud variation tracking subunit 128. The components mentioned above are electrically connected to each other.

The point cloud capturing subunit 120 is configured to obtain a point cloud information 134 based on the reflected radar wave 108. The point cloud reliability checking subunit 122 is configured to check the point cloud information 134. If the point cloud information 134 checked by the point cloud reliability checking subunit 122 is correct, the point cloud capturing subunit 120 is configured to transmit the point cloud information 134 to the point cloud classification subunit 124. In other words, the point cloud reliability checking subunit 122 has a determination mechanism (namely, a determination standard) to determine whether the point cloud information 134 is correct. If the point cloud information 134 passes the determination standard, the point cloud information 134 can be used. If the point cloud information 134 does not achieve the determination standard, the point cloud information 134 needs to be recollected/recaptured.

The point cloud classification subunit 124 is configured to classify the point cloud information 134 to obtain a point cloud classification information 126. The point cloud classification subunit 124 is configured to transmit the point cloud classification information 126 to the point cloud variation tracking subunit 128. The point cloud variation tracking subunit 128 is configured to determine whether the obstacle 30 is dynamically in the predetermined range 112 on the railway 20 based on the point cloud classification information 126, and the point cloud variation tracking subunit 128 is configured to determine a moving track and a moving speed of the obstacle 30 based on the point cloud classification information 126. If the point cloud variation tracking subunit 128 determines that the obstacle 30 is dynamically in the predetermined range 112 on the railway 20 based on the point cloud classification information 126, the user interface 116 is configured to determine that the obstacle 30 is in the predetermined range 112 on the railway 20 based on the reflected radar wave 108 (namely, the above-mentioned recitation “the point cloud variation tracking subunit 128 determines that the obstacle 30 is dynamically in the predetermined range 112 on the railway 20 based on the point cloud classification information 126” means that “the user interface 116 is configured to determine that the obstacle 30 is in the predetermined range 112 on the railway 20 based on the reflected radar wave 108”).

Before the millimeter wave radar 104 starts to determine/detect/scan, the millimeter wave radar 104 and the static object determining unit 216 are configured to use a range angle spectrum (which is also called the range angle heat map) technology to record a background reflection information in the predetermined range 112 on the railway 20. Then, after the millimeter wave radar 104 starts determining/detecting/scanning, the millimeter wave radar 104 and the static object determining unit 216 are configured to subtract the background reflection information from a current reflection information to determine whether the obstacle 30 is statically in the predetermined range 112 on the railway 20. If the millimeter wave radar 104 and the static object determining unit 216 determine that the obstacle 30 is statically in the predetermined range 112 on the railway 20 more than a predetermined time, the user interface 116 is configured to determine that the obstacle 30 is in the predetermined range 112 on the railway 20 based on the reflected radar wave 108 (namely, the above-mentioned recitation “the millimeter wave radar 104 and the static object determining unit 216 determine that the obstacle 30 is statically in the predetermined range 112 on the railway 20 more than a predetermined time” means that “the user interface 116 is configured to determine that the obstacle 30 is in the predetermined range 112 on the railway 20 based on the reflected radar wave 108”).

Moreover, the dynamic object tracking unit 118 and the static object determining unit 216 of the microprocessor 102 of the present disclosure are configured to determine a size status of the obstacle 30. If the dynamic object tracking unit 118 and the static object determining unit 216 of the microprocessor 102 determines that the size status of the obstacle 30 is smaller than a predetermined-ignored size status, the dynamic object tracking unit 118 and the static object determining unit 216 of the microprocessor 102 are configured to ignore the obstacle 30. Therefore, the present disclosure does not determine an object which does not affect the travel and the safety of the train (such as a small stone) as the obstacle 30.

The dynamic object tracking unit 118, the static object determining unit 216, the point cloud capturing subunit 120, the point cloud reliability checking subunit 122, the point cloud classification subunit 124 and the point cloud variation tracking subunit 128 can be integrated into the microprocessor 102. Namely, the respective works of the above-mentioned units/subunits are all performed by the microprocessor 102. Or, the above-mentioned units/subunits are respective microprocessors or signal processors or electronic components, so as to perform the respective works of the above-mentioned units/subunits.

For example, the dynamic object tracking unit 118 is a first microprocessor or a first signal processor; the static object determining unit 216 is a second microprocessor or a second signal processor; the point cloud capturing subunit 120 is a third microprocessor or a third signal processor; the point cloud reliability checking subunit 122 is a fourth microprocessor or a fourth signal processor; the point cloud classification subunit 124 is a fifth microprocessor or a fifth signal processor; the point cloud variation tracking subunit 128 is a sixth microprocessor or a sixth signal processor.

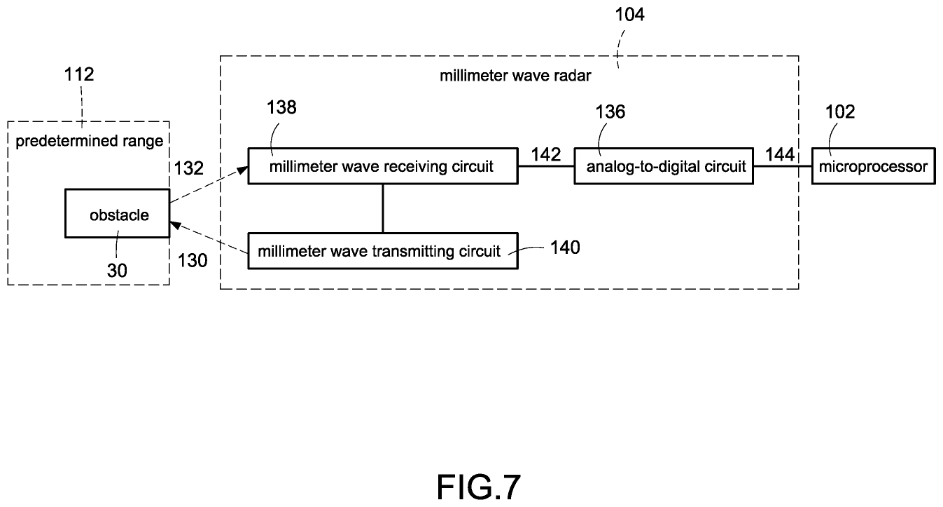

Moreover, FIG. 7 shows a block diagram of an embodiment of the millimeter wave radar of the present disclosure. Please refer to FIG. 1 to FIG. 6 together. The millimeter wave radar 104 includes an analog-to-digital circuit 136, a millimeter wave receiving circuit 138 and a millimeter wave transmitting circuit 140. The analog-to-digital circuit 136 is electrically connected to the microprocessor 102. The millimeter wave receiving circuit 138 is electrically connected to the analog-to-digital circuit 136. The millimeter wave transmitting circuit 140 is electrically connected to the millimeter wave receiving circuit 138. The millimeter wave transmitting circuit 140 is configured to transmit the radar wave 106 to the predetermined range 112 on the railway 20. The millimeter wave receiving circuit 138 is configured to receive the reflected radar wave 108 reflected from the predetermined range 112 on the railway 20 based on the radar wave 106. The millimeter wave receiving circuit 138 is configured to process the reflected radar wave 108 to obtain an analog signal 142. The millimeter wave receiving circuit 138 is configured to transmit the analog signal 142 to the analog-to-digital circuit 136. The analog-to-digital circuit 136 is configured to process the analog signal 142 to obtain a digital signal 144. The analog-to-digital circuit 136 is configured to transmit the digital signal 144 to the microprocessor 102. The digital signal 144 includes the point cloud information 134.

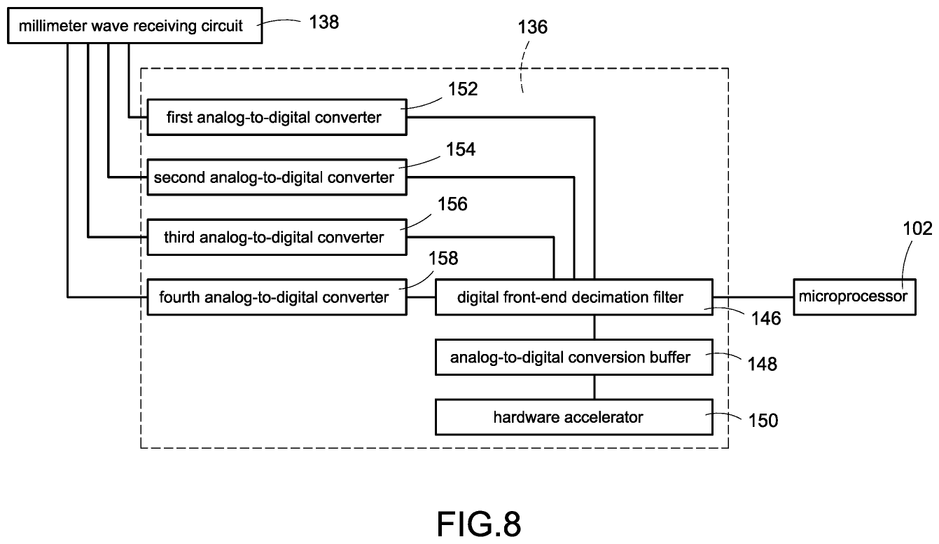

Moreover, FIG. 8 shows a block diagram of an embodiment of the analog-to-digital circuit of the present disclosure. Please refer to FIG. 1 to FIG. 7 together. The analog-to-digital circuit 136 includes a digital front-end decimation filter 146, an analog-to-digital conversion buffer 148, a hardware accelerator 150, a first analog-to-digital converter 152, a second analog-to-digital converter 154, a third analog-to-digital converter 156 and a fourth analog-to-digital converter 158. The digital front-end decimation filter 146 is electrically connected to the microprocessor 102. The analog-to-digital conversion buffer 148 is electrically connected to the digital front-end decimation filter 146. The hardware accelerator 150 is electrically connected to the analog-to-digital conversion buffer 148. The first analog-to-digital converter 152 is electrically connected to the digital front-end decimation filter 146 and the millimeter wave receiving circuit 138. The second analog-to-digital converter 154 is electrically connected to the digital front-end decimation filter 146 and the millimeter wave receiving circuit 138. The third analog-to-digital converter 156 is electrically connected to the digital front-end decimation filter 146 and the millimeter wave receiving circuit 138. The fourth analog-to-digital converter 158 is electrically connected to the digital front-end decimation filter 146 and the millimeter wave receiving circuit 138.

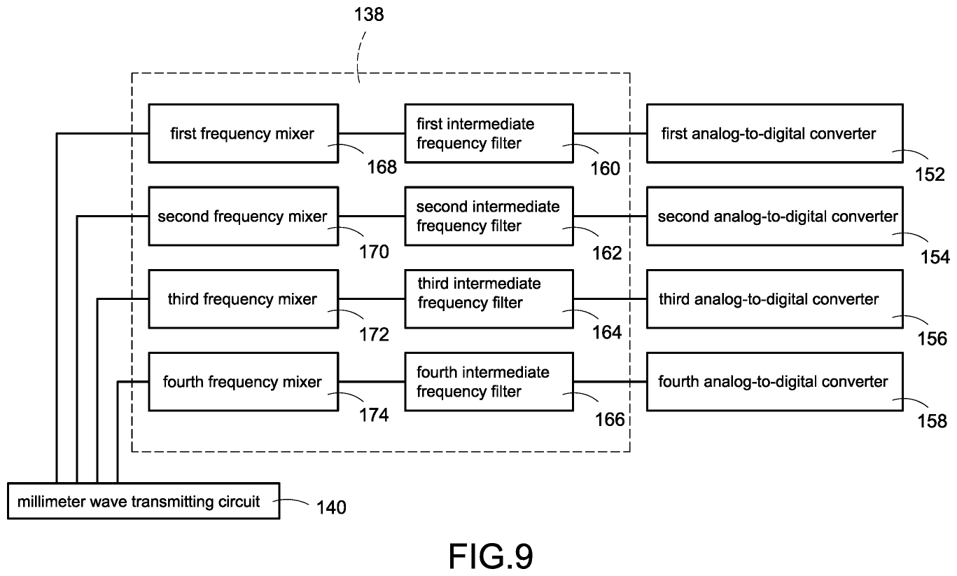

Moreover, FIG. 9 shows a partial block diagram of an embodiment of the millimeter wave receiving circuit of the present disclosure. Please refer to FIG. 1 to FIG. 8 together. The millimeter wave receiving circuit 138 includes a first intermediate frequency filter 160, a second intermediate frequency filter 162, a third intermediate frequency filter 164, a fourth intermediate frequency filter 166, a first frequency mixer 168, a second frequency mixer 170, a third frequency mixer 172 and a fourth frequency mixer 174. The first intermediate frequency filter 160 is electrically connected to the first analog-to-digital converter 152. The second intermediate frequency filter 162 is electrically connected to the second analog-to-digital converter 154. The third intermediate frequency filter 164 is electrically connected to the third analog-to-digital converter 156. The fourth intermediate frequency filter 166 is electrically connected to the fourth analog-to-digital converter 158. The first frequency mixer 168 is electrically connected to the first intermediate frequency filter 160 and the millimeter wave transmitting circuit 140. The second frequency mixer 170 is electrically connected to the second intermediate frequency filter 162 and the millimeter wave transmitting circuit 140. The third frequency mixer 172 is electrically connected to the third intermediate frequency filter 164 and the millimeter wave transmitting circuit 140. The fourth frequency mixer 174 is electrically connected to the fourth intermediate frequency filter 166 and the millimeter wave transmitting circuit 140.

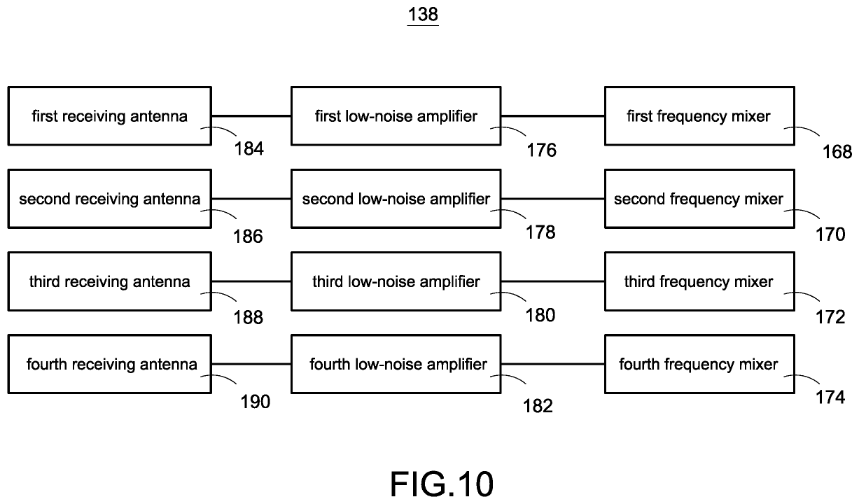

Moreover, FIG. 10 shows another partial block diagram of the embodiment of the millimeter wave receiving circuit of the present disclosure. Please refer to FIG. 1 to FIG. 9 together. The millimeter wave receiving circuit 138 further includes a first low-noise amplifier 176, a second low-noise amplifier 178, a third low-noise amplifier 180, a fourth low-noise amplifier 182, a first receiving antenna 184, a second receiving antenna 186, a third receiving antenna 188 and a fourth receiving antenna 190. The first low-noise amplifier 176 is electrically connected to the first frequency mixer 168. The second low-noise amplifier 178 is electrically connected to the second frequency mixer 170. The third low-noise amplifier 180 is electrically connected to the third frequency mixer 172. The fourth low-noise amplifier 182 is electrically connected to the fourth frequency mixer 174. The first receiving antenna 184 is electrically connected to the first low-noise amplifier 176. The second receiving antenna 186 is electrically connected to the second low-noise amplifier 178. The third receiving antenna 188 is electrically connected to the third low-noise amplifier 180. The fourth receiving antenna 190 is electrically connected to the fourth low-noise amplifier 182.

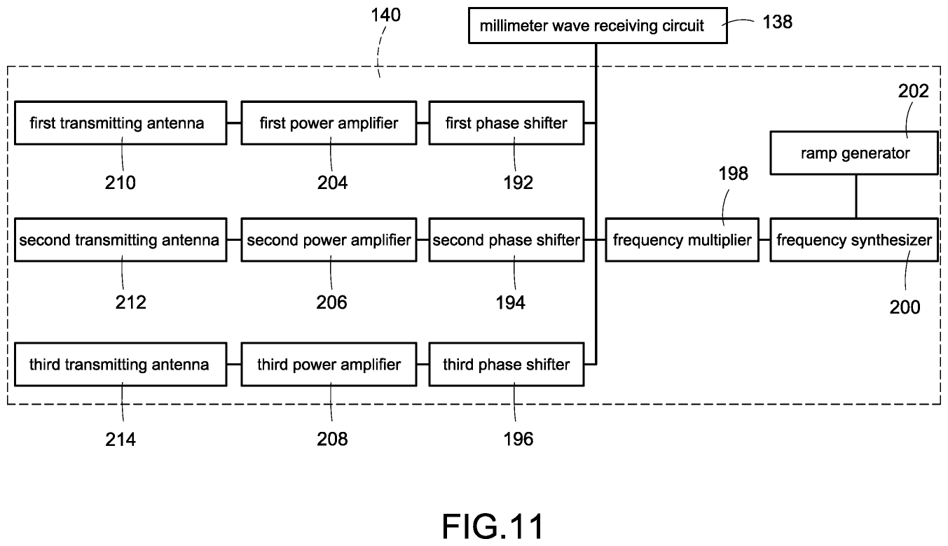

Moreover, FIG. 11 shows a block diagram of an embodiment of the millimeter wave transmitting circuit of the present disclosure. Please refer to FIG. 1 to FIG. 10 together. The millimeter wave transmitting circuit 140 includes a first phase shifter 192, a second phase shifter 194, a third phase shifter 196, a frequency multiplier 198, a frequency synthesizer 200 and a ramp generator 202. The first phase shifter 192 is electrically connected to the millimeter wave receiving circuit 138. The second phase shifter 194 is electrically connected to the millimeter wave receiving circuit 138. The third phase shifter 196 is electrically connected to the millimeter wave receiving circuit 138. The frequency multiplier 198 is electrically connected to the millimeter wave receiving circuit 138, the first phase shifter 192, the second phase shifter 194 and the third phase shifter 196. The frequency synthesizer 200 is electrically connected to the frequency multiplier 198. The ramp generator 202 is electrically connected to the frequency synthesizer 200.

Moreover, according to FIG. 11, the millimeter wave transmitting circuit 140 further includes a first power amplifier 204, a second power amplifier 206, a third power amplifier 208, a first transmitting antenna 210, a second transmitting antenna 212 and a third transmitting antenna 214. The first power amplifier 204 is electrically connected to the first phase shifter 192. The second power amplifier 206 is electrically connected to the second phase shifter 194. The third power amplifier 208 is electrically connected to the third phase shifter 196. The first transmitting antenna 210 is electrically connected to the first power amplifier 204. The second transmitting antenna 212 is electrically connected to the second power amplifier 206. The third transmitting antenna 214 is electrically connected to the third power amplifier 208.

The advantage of the present disclosure is to promptly and accurately warn that the obstacle is on the railway, so as to improve the safety of the train running on the railway. When the obstacle 30 invades the railway 20, the alarm bell 218, the warning lamp 130 and the camera lens 110 will be triggered, and the warning data will be uploaded to the cloud system 220, and the train driver can know the road conditions ahead in advance based on the warning result of the cloud system 220, so as to reduce the occurrence of the accidents.

Although the present disclosure has been described with reference to the preferred embodiment thereof, it will be understood that the disclosure is not limited to the details thereof. Various substitutions and modifications have been suggested in the foregoing description, and others will occur to those of ordinary skill in the art. Therefore, all such substitutions and modifications are intended to be embraced within the scope of the disclosure as defined in the appended claims.

What is claimed is:

1. A millimeter wave radar apparatus determining an obstacle on a railway, the millimeter wave radar apparatus applied to the railway and the obstacle, the millimeter wave radar apparatus comprising:
a user interface; and
a millimeter wave radar electrically connected to the user interface,
wherein the user interface is configured to control the millimeter wave radar; the millimeter wave radar is configured to transmit a radar wave to a predetermined range on the railway; the millimeter wave radar is configured to receive a reflected radar wave reflected from the predetermined range on the railway based on the radar wave; the user interface is configured to determine whether the obstacle is in the predetermined range on the railway based on the reflected radar wave; if the user interface determines that the obstacle is in the predetermined range on the railway, the user interface is configured to provide a warning.

2. The millimeter wave radar apparatus of claim 1, further comprising:
a camera lens electrically connected to the user interface,
wherein the user interface is configured to control the camera lens; if the user interface determines that the obstacle is in the predetermined range on the railway, the user interface is configured to control the camera lens to photograph the obstacle in the predetermined range on the railway.

3. The millimeter wave radar apparatus of claim 2, wherein the user interface comprises:
a microprocessor electrically connected to the millimeter wave radar and the camera lens.

4. The millimeter wave radar apparatus of claim 3, wherein the microprocessor comprises:
a dynamic object tracking unit electrically connected to the millimeter wave radar,
wherein the dynamic object tracking unit comprises:
a point cloud capturing subunit electrically connected to the millimeter wave radar,
wherein the point cloud capturing subunit is configured to obtain a point cloud information based on the reflected radar wave.

5. The millimeter wave radar apparatus of claim 4, wherein the dynamic object tracking unit further comprises:
a point cloud reliability checking subunit electrically connected to the point cloud capturing subunit,
wherein the point cloud reliability checking subunit is configured to check the point cloud information.

6. The millimeter wave radar apparatus of claim 5, wherein the dynamic object tracking unit further comprises:
a point cloud classification subunit electrically connected to the point cloud capturing subunit,
wherein if the point cloud information checked by the point cloud reliability checking subunit is correct, the point cloud capturing subunit is configured to transmit the point cloud information to the point cloud classification subunit; the point cloud classification subunit is configured to classify the point cloud information to obtain a point cloud classification information.

7. The millimeter wave radar apparatus of claim 6, wherein the dynamic object tracking unit further comprises:
a point cloud variation tracking subunit electrically connected to the point cloud classification subunit,
wherein the point cloud classification subunit is configured to transmit the point cloud classification information to the point cloud variation tracking subunit; the point cloud variation tracking subunit is configured to determine whether the obstacle is dynamically in the predetermined range on the railway based on the point cloud classification information, and the point cloud variation tracking subunit is configured to determine a moving track and a moving speed of the obstacle based on the point cloud classification information; if the point cloud variation tracking subunit determines that the obstacle is dynamically in the predetermined range on the railway based on the point cloud classification information, the user interface is configured to determine that the obstacle is in the predetermined range on the railway based on the reflected radar wave.

8. The millimeter wave radar apparatus of claim 7, wherein the microprocessor further comprises:
a static object determining unit electrically connected to the millimeter wave radar,
wherein before the millimeter wave radar starts to determine, the millimeter wave radar and the static object determining unit are configured to use a range angle spectrum technology to record a background reflection information in the predetermined range on the railway; then, after the millimeter wave radar starts determining, the millimeter wave radar and the static object determining unit are configured to subtract the background reflection information from a current reflection information to determine whether the obstacle is statically in the predetermined range on the railway; if the millimeter wave radar and the static object determining unit determine that the obstacle is statically in the predetermined range on the railway more than a predetermined time, the user interface is configured to determine that the obstacle is in the predetermined range on the railway based on the reflected radar wave.

9. The millimeter wave radar apparatus of claim 8, the millimeter wave radar apparatus applied to a cloud system, wherein the user interface further comprises:
a warning lamp electrically connected to the microprocessor; and
an alarm bell electrically connected to the microprocessor,
wherein if the user interface determines that the obstacle is in the predetermined range on the railway, the user interface is configured to control the camera lens to photograph the obstacle in the predetermined range on the railway to upload to the cloud system, and the user interface is configured to light the warning lamp, and the user interface is configured to drive the alarm bell to generate a warning sound; the warning lamp is configured to further display the warning; the cloud system is configured to store an incident screen photo, an obstacle distance, an incident location coordinate and an incident time.

10. The millimeter wave radar apparatus of claim 9, wherein the user interface further comprises:
a timer electrically connected to the microprocessor,
wherein if the user interface determines that the obstacle is in the predetermined range on the railway, the user interface is configured to provide the warning and is configured to utilize the timer to record an appearance time of the obstacle; if the user interface determines that the obstacle leaves the predetermined range on the railway, the user interface is configured to stop providing the warning and is configured to utilize the timer to record a departure time of the obstacle.
